(19) United States
(12) Patent Application Publication
(10) Pub. No.: US 2021/0033046 A1
(43) Pub. Date: Feb. 4, 2021

(54) Gas Admission Valve and Fuel Gas Supply Assembly with Leakage Containment Flowpath

(71) Applicant: Caterpillar Motoren GmbH & Co. KG, Kiel (DE)

(72) Inventors: EIKE SIXEL, Kiel (DE); Bejarnin BlEYER, Kiel (DE); Steven Caffail FINCH, Londo (GB)

(73) Assignee: Caterpillar Motoren GmbH & Co. KG, Kiel (DE)

(21) Appl. No.: 16/964,158

(22) PCT Filed: Feb. 1, 2019
(86) PCT No.: PCT/EP2019/025035

§ 371 Date: Jul. 22, 2020

(30) Foreign Application Priority Data
Feb. 5, 2018 (GB) 1801862.2

(51) Int. Cl. F02M 21/02; F02F 1/24

(52) U.S. Cl. CPC F02M 21/026; F02M 21/0293; F02M 21/0245; F02F 1/242

(57) ABSTRACT

A fuel gas supply assembly for an internal combustion engine defines a leakage containment flowpath which includes a leakage containment space formed between the body of a gas admission valve and the wall defining the inner surface of a compartment formed in the cylinder head of the engine in which the gas admission valve is mounted. The gas admission valve is sealingly connected in fluid communication with the fuel gas conduit of a conduit assembly via a first aperture of the compartment so that both the fuel gas flowpath and the leakage containment space extend along and at least partially around a common portion of the length axis of the compartment. In another aspect, a gas admission valve includes an internal leakage containment flowpath formed by a leakage containment compartment which is interposed between the actuator and the fuel gas flowpath within the gas admission valve and sealingly connected to the leakage containment flowpath.

### TECHNICAL FIELD

This invention relates to arrangements for supplying a fuel gas via a gas admission valve to a combustion chamber of an internal combustion engine, wherein a leakage containment flowpath is provided to contain fuel gas leaking from the fuel gas flowpath.

In this specification, a gas admission valve means a valve comprising a valve element and an actuator operable to move the valve element to control a flow of fuel gas passing through the gas admission valve. The actuator may be for example a solenoid, in which case the gas admission valve is referred to as a solenoid operated gas admission valve.

### BACKGROUND

Large gas or dual fuel internal combustion engines are commonly used for example in ships' propulsion systems and in terrestrial power stations or gas pumping stations. It is common to supply each combustion chamber of the engine with fuel gas (e.g. natural gas, propane, syngas, etc.) via an individual gas admission valve which may be operable, for example, to adjust the power output of the combustion chamber by changing the timing or duration of the open cycle of the gas admission valve on each cycle of the engine.

It is common, particularly in marine applications, to supply each gas admission valve with fuel gas via a double walled pipe, with the outer wall defining an annular leakage containment flowpath surrounding the fuel gas flowpath. The leakage containment flowpath may be evacuated or purged with an inert gas or air, and may be fitted with detectors so that any leakage of fuel gas into the leakage space can be detected and safely vented remotely from the engine.

In this specification, a leakage containment flowpath means a space defined within a compartment which can sealingly contain or conduct a fluid leaking into the compartment, particularly a gas, irrespective of whether or not the compartment is arranged to direct the fluid to flow through the compartment. Thus, a compartment defining a flowpath may be formed for example at an extremity of a conduit which forms the only outlet from the compartment, so as to contain a fuel gas entering into the compartment from a leakage point, or to conduct the fuel gas via the conduit away from the leakage point to a location where it can be vented safely to atmosphere.

Double walled fuel gas admission valves defining a leakage containment flowpath are known for example from U.S. Pat. No. 8,720,488 B2 and KR 101393217 B1.

WO 2014/076367 discloses an arrangement in which a gas admission valve is mounted in a compartment which communicates fluidly with the outer annulus of a double walled supply pipe. The fuel gas flows from the inlet valve into pipework carrying the charge air supply, through which the gas/air mixture may flow to the combustion chamber of an engine.

In other known arrangements, a gas admission valve may be arranged in a housing formed as a recess in a cylinder head of an engine.

U.S. Pat. No. 9,624,873 B2 for example discloses a gas fuelled internal combustion engine in which the cylinder head defines a housing containing a solenoid operated gas admission valve. A leakage containment flowpath is defined between the valve and the housing or between inner and outer walls of the housing, and connected to the communicating leakage containment flowpath of a double walled conduit which supplies fuel gas to the valve.

The electrically powered solenoid actuator is mounted in the fuel gas supply flowpath, which extends axially around and past the solenoid actuator and then through the moving valve element below it.

For better understanding of the present disclosure, FIGS. 7 and 8 show by way of example another possible arrangement in which the inner and outer flowpaths of a double walled conduit are sealingly connected to respective apertures in the cylinder head of an internal combustion engine. The apertures open into a recess in which a solenoid operated gas admission valve is housed. O-ring seals are arranged between the gas admission valve and the housing to sealingly connect the inner flowpath with the fuel gas inlet of the gas admission valve, and the outer flowpath with an annular, leakage containment space extending around the gas admission valve body respectively above and below the fuel gas inlet. The electrically powered solenoid actuator is located out of the fuel gas supply flowpath.

Although the cylinder head generally provides a satisfactory gas tight enclosure for the fuel gas and fuel/air mixture, it is important to ensure that the cylinder head does not develop any fault such as a crack as illustrated which could compromise its gas tight integrity.

### Summary

According to a first aspect of the present disclosure there is provided an assembly including a gas admission valve for supplying a fuel gas to a combustion chamber of an internal combustion engine. In a second aspect the disclosure provides a gas admission valve.

The gas admission valve generally comprises a body having an inlet and an outlet, with a fuel gas flowpath extending within the body from the inlet to the outlet. An actuator, optionally a solenoid, is operable to move a valve element to open and close the fuel gas flowpath to control a flow of fuel gas from the inlet to the outlet.

The gas admission valve is received in use in a compartment defined by a housing having a first, open end and forming part of a cylinder head of the engine. A first aperture opens through the wall of the compartment between its first and second ends, with a second aperture connecting the compartment (via an internal flowpath) with the combustion chamber of the engine. In its use position, the outlet of the gas admission valve is sealing connected in fluid communication with the second aperture of the compartment, with a leakage containment space being arranged between the body of the gas admission valve and the wall of the compartment.

The assembly includes a conduit assembly comprising a fuel gas conduit and a leakage containment conduit surrounding the fuel gas conduit and arranged so that the fuel gas flowpath extends through the fuel gas conduit, and the leakage containment space forms part of a leakage containment flowpath extending through the leakage containment conduit.

In the first aspect, the inlet of the gas admission valve is sealingly connected in fluid communication with the fuel gas conduit via the first aperture of the compartment, so that the fuel gas flowpath and the leakage containment space extend along and partially around a common portion of a length axis of the compartment.

In the second aspect, the gas admission valve includes an internal leakage containment flowpath formed by a leakage containment compartment which is interposed between the actuator and the fuel gas flowpath within the gas admission valve. In use, the leakage containment flowpath within the gas admission valve is sealingly connected in fluid communication with the leakage containment flowpath of the housing and conduit assembly external to the gas admission valve.

### BRIEF DESCRIPTION OF THE DRAWINGS

Further features and advantages will become evident from the following illustrative embodiments which will now be described, purely by way of example and without limitation to the scope of the claims, and with reference to the accompanying drawings, in which:

FIG. 1 is a plan view of one gas admission valve compartment formed in the cylinder head of an internal combustion engine, shown more generally in FIG. 32;

FIG. 2 is a section taken at II-I through the gas admission valve compartment of FIG. 1;

FIGS. 3 and 4 show a first solenoid operated gas admission valve, provided by way of example for better understanding of the various illustrated embodiments, with FIG. 4 showing the body partially cut away;

FIGS. 5 and 6 show a first conduit assembly, respectively in side view and in longitudinal section;

FIG. 7 shows the first solenoid operated gas admission valve and first conduit assembly installed at the solenoid operated gas admission valve compartment of FIG. 1 to form an example assembly, which also is provided by way of example for better understanding of the various illustrated embodiments;

FIG. 8 is a section taken at VIII-VIII of FIG. 7;

FIG. 9 shows a second solenoid operated gas admission valve;

FIG. 10 is a partially cut away view of the second solenoid operated gas admission valve in a first embodiment thereof;

FIG. 11 is a partially cut away view of the second solenoid operated gas admission valve in a second embodiment thereof;

FIGS. 12 and 13 show a second conduit assembly, respectively in side view and in longitudinal section;

FIG. 14 is a section taken at XIV-XIV of FIG. 15;

FIG. 15 shows the second conduit assembly installed at the gas admission valve compartment of FIG. 1;

FIG. 16 is the section of FIG. 14 showing the second solenoid operated gas admission valve in the embodiment of FIG. 11 installed in the gas admission valve compartment to form a second assembly;

FIG. 17 shows a third solenoid operated gas admission valve;

FIGS. 18 and 19 are partially cut away views of the third solenoid operated gas admission valve respectively in first and second embodiments thereof, corresponding generally to the first and second embodiments of the second solenoid operated gas admission valve;

FIGS. 20 and 21 show a first insert, respectively in side and top views;

FIG. 22 is a longitudinal section through the first insert taken at XXII-XXII of FIG. 22;

FIG. 23 is a section taken at XXIII-XXIII of FIG. 24;

FIG. 24 shows a third conduit assembly installed together with the first insert at the gas admission valve compartment of FIG. 1;

FIG. 25 is the section of FIG. 23 showing the third solenoid operated gas admission valve in the embodiment of FIG. 19 installed within the first insert in the gas admission valve compartment to form a third assembly;

FIGS. 26 and 27 show a second insert, respectively in side and top views;

FIG. 28 is a longitudinal section through the second insert taken at XXVIII-XXVIII of FIG. 27;

FIG. 29 is a section corresponding to FIG. 2 showing a fourth conduit assembly installed at the gas admission valve compartment of FIG. 1, wherein the first aperture of the gas admission valve compartment is adapted to provide a seal;

FIG. 30 is the section of FIG. 29 showing the second insert installed in the gas admission valve compartment;

FIG. 31 is the section of FIG. 30 showing the third solenoid operated gas admission valve in the embodiment of FIG. 18 installed within the second insert in the gas admission valve compartment to form a fourth assembly;

FIG. 32 shows a portion of the engine including four gas admission valve compartments;

FIG. 33 shows a third insert in top view;

FIG. 34 shows a fifth conduit assembly installed together with the third insert at the gas admission valve compartment of FIG. 1;

FIGS. 35, 36 and 37 are sections taken at XXXV-XXXV of FIG. 34 showing sequential steps in the installation of the third insert;

FIG. 38 is the section of FIGS. 35-37 showing the third solenoid operated gas admission valve in the embodiment of FIG. 19 installed within the third insert in the gas admission valve compartment to form a fifth assembly;

FIG. 39 shows a variant of the fifth conduit assembly together with a variant of the third solenoid operated gas admission valve in the embodiment of FIG. 19, which is installed within the gas admission valve compartment to form a sixth assembly; and

FIGS. 40, 41 and 42 are sections at XL-XL of FIG. 39 showing sequential steps in the installation of the gas admission valve in the compartment.

Reference numerals appearing in more than one of the figures indicate the same or corresponding parts in each of them.

### DETAILED DESCRIPTION

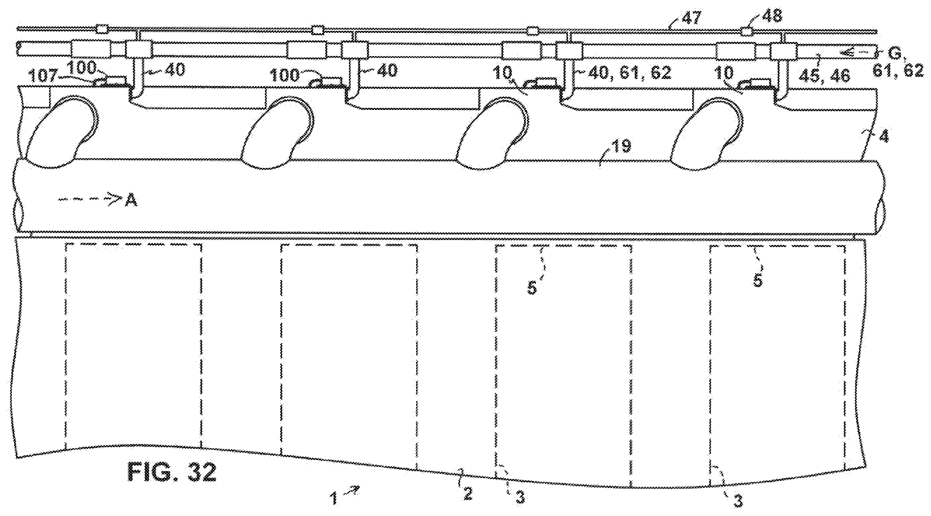

Referring to FIG. 32, an internal combustion engine 1 comprises an engine block 2 containing combustion chambers 3, and a cylinder head 4 mounted on the engine block to form an upper end wall 5 of one or more of the combustion chambers or cylinders. The cylinder head is a closure which is removable to provide access to the combustion chamber for installation or removal of a piston (or other moving element) contained in the combustion chamber. The cylinder head may be formed as a monolithic casting (e.g. of iron, steel, aluminium or other metal or metal alloy). The cylinder head may form an upper end wall of several combustion chambers 3, as shown. Alternatively, the engine may comprise several cylinder heads 4, each forming an upper end wall 5 of a respective one of the combustion chambers 3, as known in the art.

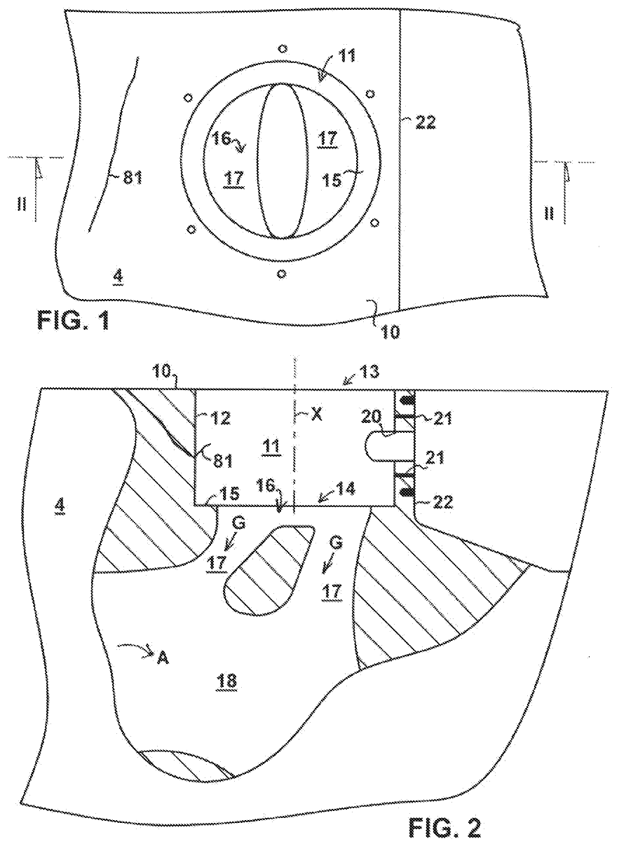

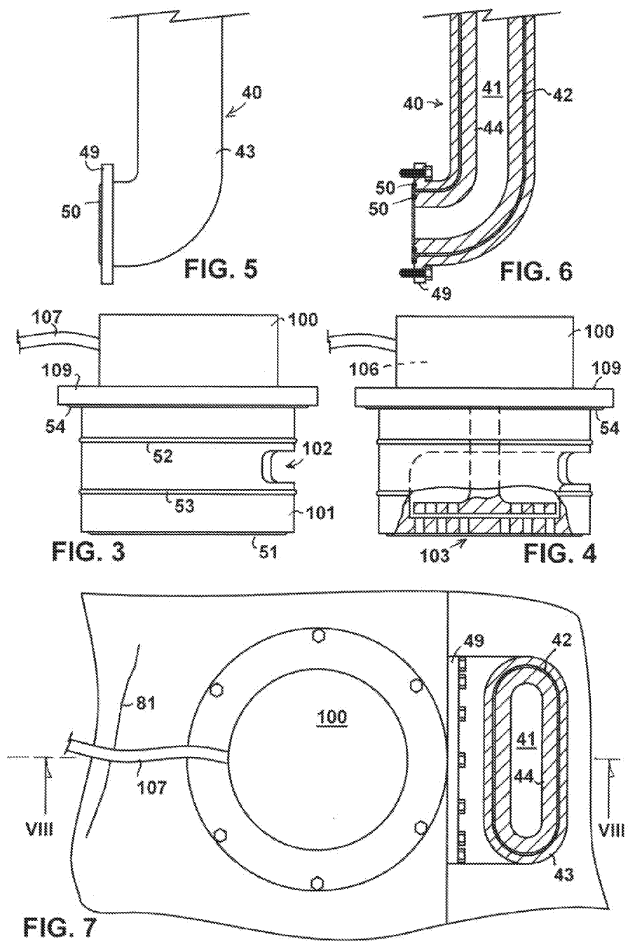

Referring also to FIGS. 1 and 2, each combustion chamber is supplied with fuel gas via a gas admission valve 100 (FIGS. 3 and 4) mounted in a gas admission valve housing 10 which is formed as a permanent or integral part of the cylinder head 4. In each of the illustrated embodiments the gas admission valve is a solenoid operated gas admission valve, which is to say, the actuator of the valve is a solenoid, although it will be understood that other types of actuation are possible. The housing 10 comprises a compartment 11 defined by a wall 12 (which is to say, the wall forms the surface bounding the compartment).

The compartment 11 may be cast or bored in a unitary body of material, e.g. a metal casting, forming the cylinder head 4, with the exposed surface of the material forming the wall 12. In the example shown, the generally cylindrical portion of the wall extending between the first, open end 13 and the opposite, second end 14 of the compartment 11 forms a surface of rotation about the length axis X of the compartment. The wall 12 extends radially inwardly towards the length axis X at the second end of the compartment to form an annular surface 15 surrounding the second aperture 16 of the compartment, via which the compartment 11 fluidly communicates (typically indirectly, through an internal flowpath 18 forming an intake air duct) with a respective one of the combustion chambers 3 of the engine.

In use, fuel gas G flowing via the solenoid operated gas admission valve 100 through the second aperture 16 passes through two channels 17 and enters the internal flowpath 18 of the engine, in which it mixes with charge air A supplied by external charge air ducting 19. The fuel/air mixture then flows to the combustion chamber 3, typically via combustion chamber valves (not shown), where the mixture is ignited to reciprocate the piston and generate output shaft power as well known in the art. Other energy conversion arrangements of course are possible.

The fuel gas G is arranged to enter the compartment 11 via a first aperture 20 formed in the wall 12 between the first and second ends of the compartment. In the example of FIG. 2, small leakage containment apertures 21 are also formed in the wall 12 of the compartment 11. The first aperture 20 and leakage containment apertures 21 extend from the compartment to an external surface 22 of the cylinder head at which they are fluidly connected respectively with a fuel gas conduit 41 and leakage containment conduit 42 of a first conduit assembly 40, as shown in FIGS. 5 and 6 and in cross-section in FIG. 7.

The first conduit assembly 40 comprises an outer wall 43 and an inner wall 44, with the fuel gas conduit 41 defined within the inner wall and the leakage containment conduit 42 defined between the inner and outer walls so that it surrounds the fuel gas conduit 41 to receive and contain any fuel gas leaking from the fuel gas conduit. As shown in FIG. 32, the fuel gas conduit 41 of the conduit assembly 40 may be connected to a common, double walled fuel gas conduit 45 forming a fuel gas supply rail for all of the gas admission valves, with the leakage containment conduit 42 similarly communicating with an outer, leakage containment conduit 46 formed between the double walls of the fuel gas conduit 45 which may be purged or evacuated via inert gas purging lines 47, which may include leakage containment safety devices 48 such as purging valves, leakage sensors as the like as known in the art.

The fuel gas conduits 41, 45 together form a fuel gas flowpath 61 extending through the fuel gas conduits 41 and 45, while the leakage containment conduits 42, 46 together form a leakage containment flowpath 62 extending through the leakage containment conduits 42 and 46. The leakage containment flowpath is fluidly separated from the fuel gas flowpath so that fuel gas flowing through the fuel gas flowpath cannot enter the leakage containment flowpath unless a fault develops.

The conduit assembly 40 terminates at a connection flange 49 with seals 50 via which the conduit assembly 40 is sealingly connected to the housing 10 with the fuel gas conduit and the leakage containment conduit in fluid communication respectively with the first aperture 20 and the leakage containment apertures 21.

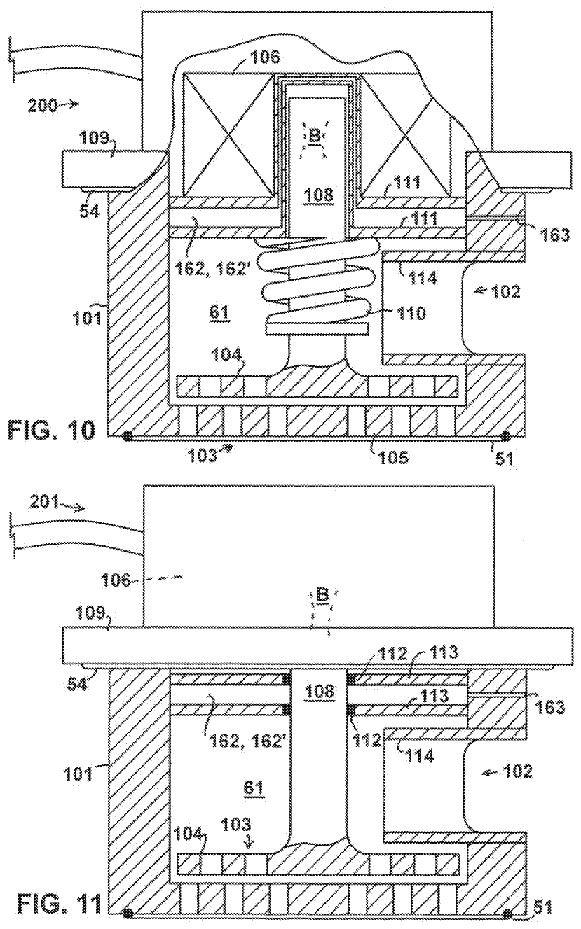

First solenoid operated gas admission valve Referring to FIGS. 3 and 4, the first solenoid operated gas admission valve 100 is generally of known type, comprising a body 101, the body including an inlet 102 and an outlet 103. The fuel gas flowpath 61 extends within the body from the inlet 102 to the outlet 103. A valve element 104 is mounted to engage a valve seat 105 formed in the body. Typically as illustrated the valve element 104 and valve seat 105 define multiple passages which together maximise the section area of the fuel gas flowpath within the solenoid operated gas admission valve. An inductive electrical coil or solenoid coil 106 (better seen in FIG. 10) is operable by an electrical current or signal via a control cable 107 from an engine control system (not shown) to generate a magnetic field B which moves the valve element 104 to open and close the fuel gas flowpath 61 within the solenoid operated gas admission valve to control the flow of fuel gas G from the inlet to the outlet.

The valve element 104 is connected to (or integral with) a magnet responsive element or armature 108, such as an iron or steel body, which in the simplified example shown is formed as a stem and is moveable together with the valve element 104 by the magnetic field B, the armature and coil together forming a solenoid which actuates the valve element. Those skilled in the art will recognise that other arrangements may be adopted to couple the valve element 104 or other magnet responsive element with the magnetic field from the coil.

### Example Assembly

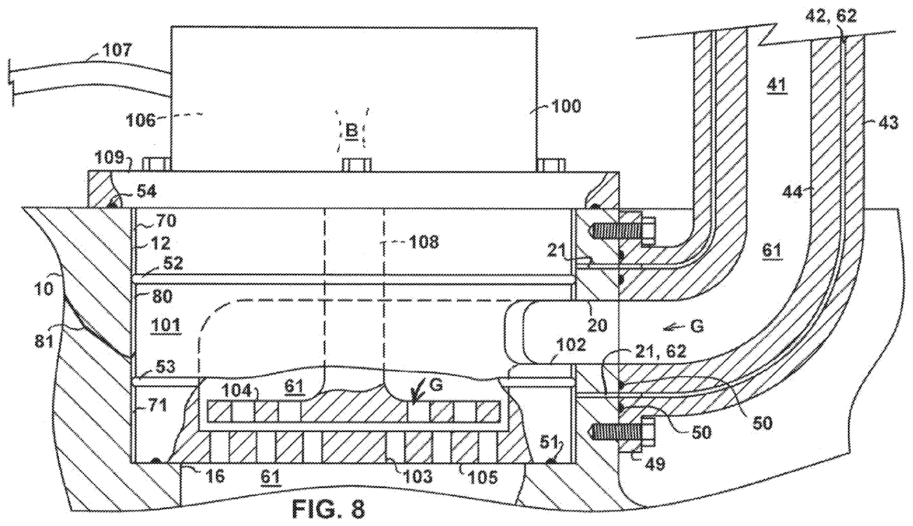

In the example assembly of FIGS. 7 and 8, the solenoid operated gas admission valve 100 is received in the compartment 11 in a use position wherein the outlet 103 of the solenoid operated gas admission valve is sealingly connected in fluid communication with the second aperture 16 of the compartment. The body 101 of the solenoid operated gas admission valve is sealed to the wall 12 of the compartment 11 by a lower seal 51 which engages the annular surface 15, upper and lower O-ring seals 52, 53 which are spaced apart along the length axis of the compartment 11, and an upper seal 54 arranged between a mounting flange 109 of the valve body and an upper surface of the portion of the cylinder head forming the housing 10. Two annular leakage containment spaces 70, 71 are arranged between the body 101 of the valve and the wall 12 of the compartment, both spaces surrounding the valve. The first leakage containment space 70 is defined between the upper O-ring seal 52 and the upper seal 54, and the lower leakage containment space 71 between the lower O-ring seal 53 and the lower seal 51.

The example assembly illustrates how both leakage containment spaces may be arranged in fluid communication with the leakage containment conduit 42 via respective upper and lower leakage containment apertures 21 as shown, so that the leakage containment spaces form part of the leakage containment flowpath 62. Any fuel gas leaking into the leakage containment spaces 70, 71 may thus be extracted and detected and/or vented safely to atmosphere via the leakage containment conduit 46 (FIG. 32).

The inlet 102 of the solenoid operated gas admission valve is sealingly connected in fluid communication with the fuel gas conduit 41 via the first aperture 20 of the compartment by means of the upper and lower O-ring seals 52, 53 which define an gas filled annular space 80 between the valve body and the wall 12 through which fuel gas can flow from the fuel gas conduit via the fuel gas flowpath 61 through the valve to its outlet 103.

The illustrated arrangement would be generally reliable since under normal service and maintenance conditions the cylinder head provides a continuous barrier between the external environment and the internal flowpaths of the engine. Exceptionally however, in the event of improper assembly and where a fault condition goes undetected, a crack 81 may develop in the cylinder head. In the illustrated example of FIGS. 7 and 8 it can be seen that a crack 81 forms a leakage path through the cast material of the cylinder head between the gas filled annular space 80 and the external environment.

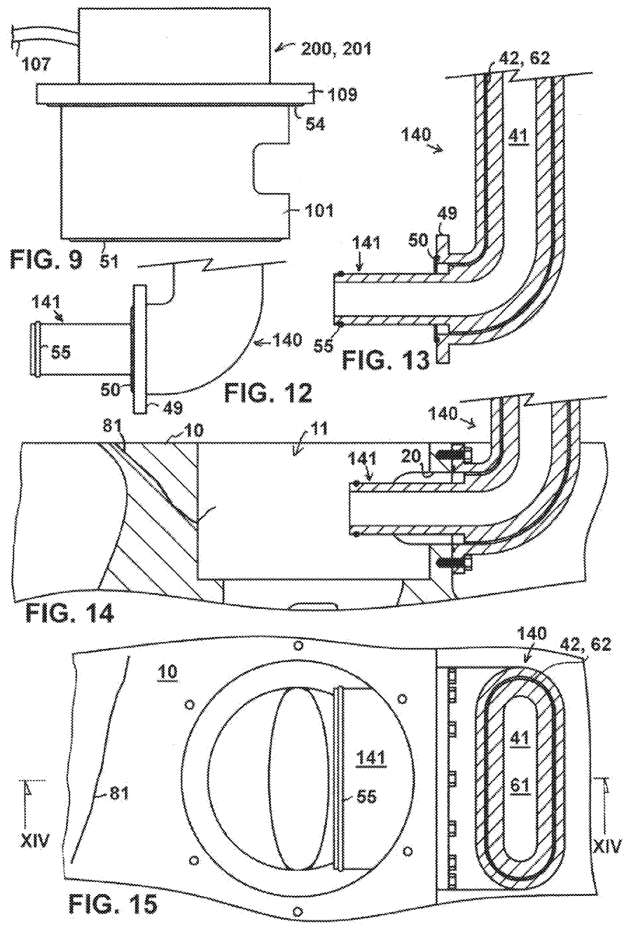

Second and third solenoid operated gas admission valve Referring to FIGS. 9-11, a second solenoid operated gas admission valve 200, 201 comprises generally similar features to the first solenoid operated gas admission valve 100, which therefore will not be described again. Unlike the first solenoid operated gas admission valve however, the second solenoid operated gas admission valve includes an internal leakage containment flowpath 162 formed by a leakage containment compartment 162′ which is interposed between the solenoid coil 106 and the fuel gas flowpath 61 within the solenoid operated gas admission valve. The leakage containment flowpath 162 within the solenoid operated gas admission valve is sealingly connectable in the installed use position of the solenoid operated gas admission valve in fluid communication with the leakage containment flowpath 62 of the housing 10 and conduit assembly 40 external to the solenoid operated gas admission valve so that the Towpaths 62, 162 form a continuous leakage containment flowpath, whereby any fuel gas leaking from the fuel gas flowpath 62 within the solenoid operated gas admission valve may be extracted from the leakage containment compartment 162′ before it reaches the electrical parts.

In each of the illustrated embodiments, the body 101 of the second solenoid operated gas admission valve 200, 201 comprises a leakage containment port 163 which opens at an external surface of the body 101 and communicates with the internal leakage containment Towpath 162, via which the internal leakage containment flowpath 162 may be sealingly connected in fluid communication with the external leakage containment flowpath 62 of the housing and conduit assembly.

In a first embodiment of the second solenoid operated gas admission valve 200 as shown in FIGS. 9 and 10, the valve element 104 includes a magnet responsive element 108 (either forming the valve element 104 or connected to it) which is moveable by a magnetic field B generated by the solenoid coil 106 and passing through the internal leakage containment flowpath 162. Thus, no moving parts of the valve element 104 extend through the leakage containment flowpath 162, which separates all the moving parts of the valve element 104 from the solenoid coil 106.

The internal leakage containment flowpath may be formed as shown between two thin walls 111 which are spaced apart axially and radially to define two closed, coaxial tubes in which the magnet responsive element 108 reciprocates. The tubes may be surrounded by the solenoid coil 106 as shown. A bias means such as a spring 110 will generally be provided to urge the valve element to the closed position; the bias means is not shown in the other illustrated solenoid operated gas admission valves but may be arranged in any suitable configuration as known in the art. Of course, the valve element and magnet responsive element may be formed other than as illustrated.

In a second embodiment of the second solenoid operated gas admission valve 201 as shown in FIGS. 9 and 11, the valve element 104 comprises a reciprocating stem 108 which passes sealingly through the leakage containment flowpath 162. In the illustrated example this is accomplished by two sliding seals 112 which surround the stem 108 and allow it to move slidingly and sealingly relative to the spaced walls 113 defining the leakage containment compartment 162′.

In variants of the second embodiment, the solenoid may be replaced by another type of actuator, such as a mechanical actuator, a pneumatic actuator, or another type of electrical actuator such as a linear electric motor, with the stem 108 being connected to the actuator above the sliding seals.

Of course, irrespective of the actuator type, other sealing arrangements such as flexible diaphragm or bellows seals or the like may be employed. In each case, and as illustrated, the leakage containment compartment may be defined by two spaced walls 113, each of which has (or forms or consists of) a separate seal (whether sliding, e.g. seal 112, or flexible), whereby the two seals are also spaced apart, while the stem 108 may be a solid body of material as shown. The surface of the stem 108 may form an internal, i.e. wetted surface of the leakage compartment, as shown.

By way of example, instead of using sliding seals 112, the walls 113 as illustrated might be formed by flexible diaphragms which are fixedly and sealingly connected to the stem 108 at two positions spaced apart along the axis of the stem, e.g. at the position of the illustrated seals 112, so that the walls 113 move together with the stem 108 as it reciprocates in use.

In such arrangements, the integrity of the leakage containment flowpath as a barrier between the fuel gas flowpath and the solenoid coil cannot be compromised by failure of a single one of the seals or flexible walls, while any leakage of fuel gas into the leakage containment compartment resulting from mechanical wear of the seals or flexible walls may be detected and extracted via the conduit assembly by maintaining a negative pressure in the external leakage containment flowpath 62 of the conduit assembly 40.

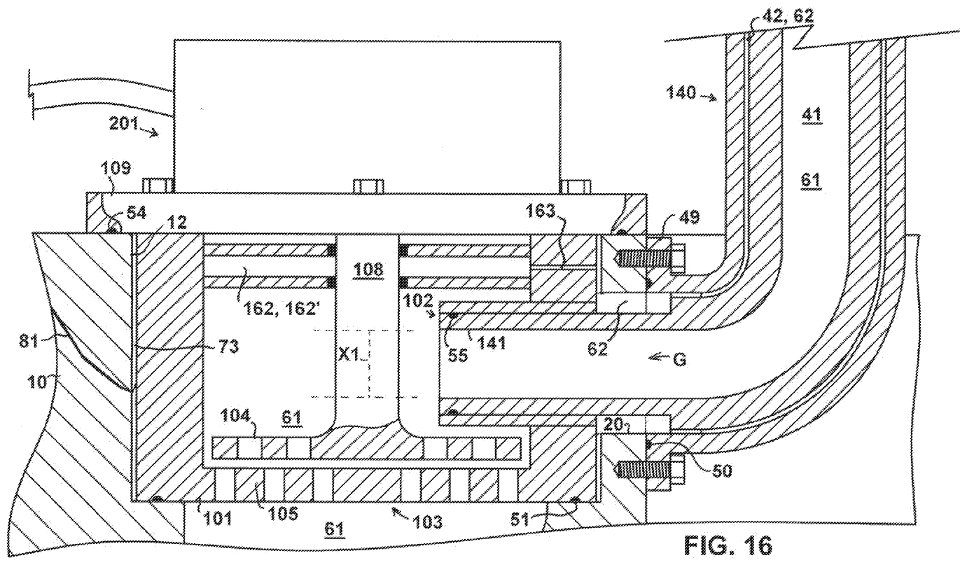

In each of the illustrated embodiments, the inlet 102 of the second solenoid operated gas admission valve 200, 201 defines a sealing surface 114 which in use engages an extension 141 of the fuel gas conduit 41 as shown in FIG. 16. The external surface of the solenoid operated gas admission valve body includes an upper seal 54 and a lower seal 51 generally as described with reference to the first solenoid operated gas admission valve.

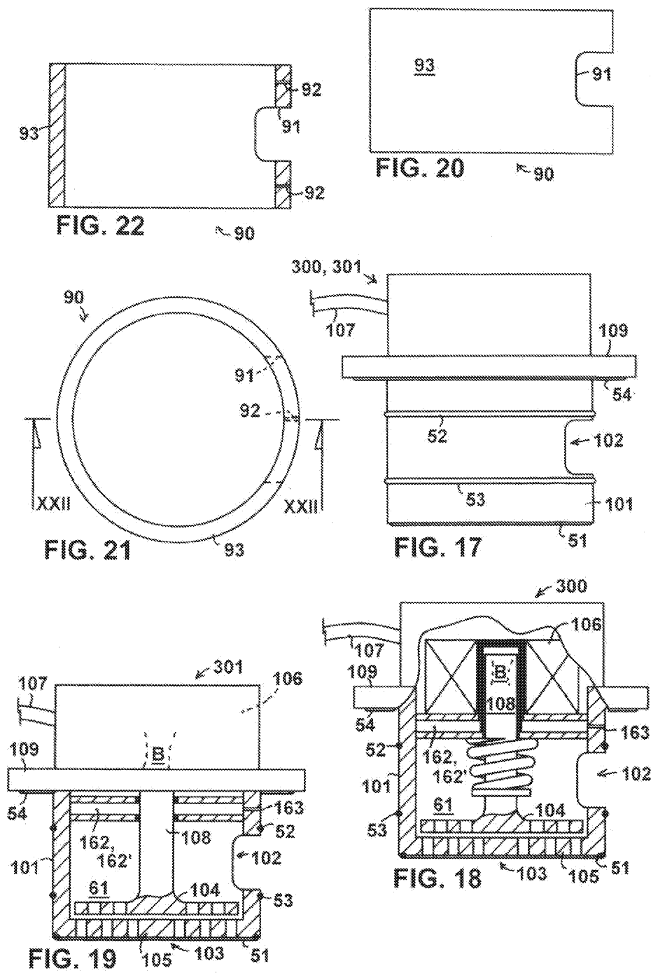

Referring to FIGS. 17-19, a third solenoid operated gas admission valve 300, 301 comprises in a first embodiment 300 (FIGS. 17 and 18) generally the same features as the second solenoid operated gas admission valve 200 (FIGS. 9 and 10), and in a second embodiment 301 (FIGS. 17 and 19) generally the same features as the second solenoid operated gas admission valve 201 (FIGS. 9 and 11), which common features will not be described again.

The third solenoid operated gas admission valve is distinguished from the second solenoid operated gas admission valve in that the inlet 102 of the third solenoid operated gas admission valve does not include a sealing surface, while the external surface of the solenoid operated gas admission valve body includes upper and lower O-ring seals 52, 53 as well as upper seal 54 and lower seal 51, all generally as described with reference to the first solenoid operated gas admission valve. Again, another type of actuator may be substituted for the solenoid if desired.

### Second, Third and Fourth Assemblies

Referring particularly to FIGS. 16, 25 and 31, it can be seen that in each of the second, third and fourth assemblies, in the installed position of the conduit assembly as shown, the solenoid operated gas admission valve 201, 300, 301 is received in the compartment 11 in a use position generally as described with reference to the first, example assembly, wherein the outlet 103 of the solenoid operated gas admission valve is sealingly connected in fluid communication with the second aperture 16 of the compartment 11. The body 101 of the solenoid operated gas admission valve is sealed to the wall 12 of the compartment 11 by a lower seal 51 which engages the annular surface 15, and an upper seal 54 arranged between a mounting flange 109 of the valve body and an upper surface of the housing 10. A leakage containment space 73, 74 is arranged between the body 101 of the solenoid operated gas admission valve and the wall 12 of the compartment 11 in fluid communication with the leakage containment conduit 42, so that the leakage containment space 73, 74 forms part of the leakage containment flowpath 62. As in the first, example assembly, any fuel gas leaking into the leakage containment space 73, 74 may thus be extracted and detected and/or vented safely to atmosphere via the leakage containment conduit 46 (FIG. 32).

In each case however, unlike the first, example assembly, the inlet 102 of the solenoid operated gas admission valve is sealingly connected in fluid communication with the fuel gas conduit 41 of the conduit assembly via the first aperture 20 of the compartment 11 so that the fuel gas flowpath 61 and the leakage containment space 73, 74 extend along and at least partially around a common portion X1 of the length axis X of the compartment 11. The common portion X1 is indicated in each of FIGS. 16, 25 and 31 by the broken lines indicating the intersection of the projected, upper and lower boundaries of the fuel gas flowpath 61 in the region where it crosses the leakage containment space 73, 74 with the length axis X as shown in the longitudinal section containing the axis X.

In the axial length portion X1 of the compartment, the leakage containment space 73, 74 extends, when considered in plan view, i.e. looking in the direction of the axis X as shown in FIG. 1, angularly around the axis X and around the solenoid operated gas admission valve except at that part of the leakage containment space 73, 74 which is occupied by the fuel gas flowpath.

In each of the second, third and fourth assemblies, it can further be seen that the leakage containment space 73, 74 extends entirely around the length axis X of the compartment 11 both above and below (i.e. axially outward of) the fuel gas flowpath 61 where it crosses the leakage containment space 73, 74, so as to surround that portion of the fuel gas flowpath 61 which passes through the leakage containment space 73, 74. Further, as illustrated, the leakage containment space 73, 74 may extend fluidly continuously for the entire axial length of the compartment 11.

In each of the illustrated examples, it can be seen that the crack 81 opens into the leakage containment space 73, 74, and so, unlike the first, example assembly, does not form a leakage path through the cast material of the cylinder head 4 between the fuel gas flowpath 61 and the external environment.

Although the second, third and fourth assemblies are illustrated with the second and third solenoid operated gas admission valves installed in the compartment 11, it will be understood that a conventional solenoid operated gas admission valve such as the first solenoid operated gas admission valve 100, or a gas admission valve with another type of actuator instead of a solenoid, could alternatively be used.

In each of the illustrated examples, the shape and size of the first aperture 20 of the compartment 11 and the arrangement of the leakage containment apertures 21 are adapted as required to suit the other components of the assembly.

It will also be noted that the cross-sectional shape of the conduit assembly differs slightly in each embodiment, which however is not functionally significant; those skilled in the art will appreciate that any convenient cross-sectional shape (circular, polygonal, or otherwise) may be selected to suit the installation.

Second assembly Referring to FIGS. 12 and 13, a second conduit assembly 140 comprises generally similar features to the first conduit assembly 40, which features will not be described again.

The second conduit assembly 140 differs from the first conduit assembly 40 in that the fuel gas conduit 41 is extended beyond the connection flange 49 to form an extension 141 of the fuel gas conduit 41, with a seal 55 at its projecting end.

FIGS. 14 and 15 illustrate that the extension 141 projects through the first aperture 20 into the compartment 11 when the second conduit assembly 140 is sealingly connected to the housing 10 in its installed position. For this reason, the solenoid operated gas admission valve of the second assembly is installed in the compartment 11 before installing the second conduit assembly 140 as shown in FIG. 16.

Referring to FIG. 16, it can be seen that in the second assembly the extension 141 of the fuel gas conduit 41 extends through the housing 10 via the first aperture 20 and into the compartment 11, and the leakage containment flowpath 62 extends through the first aperture 20 between the extension 141 of the fuel gas conduit 41 and the wall 12 of the compartment 11 in fluid communication with the leakage containment space 73. In this arrangement, no leakage containment apertures 21 are required. The extension 141 of the fuel gas conduit 41 is sealingly connected directly to the body 101 of the solenoid operated gas admission valve via its sealing surface 114.

The leakage containment space 73 extends entirely around the axis X and the body 101 of the solenoid operated gas admission valve to surround the extension 141 of the fuel gas conduit 41 where it enters the compartment 11 via the aperture 20. The leakage containment space is fluidly continuous over the entire axial length of the compartment 11 between seals 51 and 54.

In alternative embodiments, the conduit assembly may be adapted so that the fuel gas conduit 41 does not project or projects only slightly into the compartment 11, and sealingly engages the inlet of the body 101 of the solenoid operated gas admission valve. For example, a compressible seal (not shown) may be arranged between the valve body 101 and an axial end surface of the fuel gas conduit 41 so that the seal is compressed as the valve is slidingly inserted into the compartment 11 or as the valve is moved slightly to its centralised, installed position within the compartment 11. The solenoid operated gas admission valve may thus be inserted into and removed from the compartment 11 without removing the conduit assembly.

### Third and Fourth Assemblies

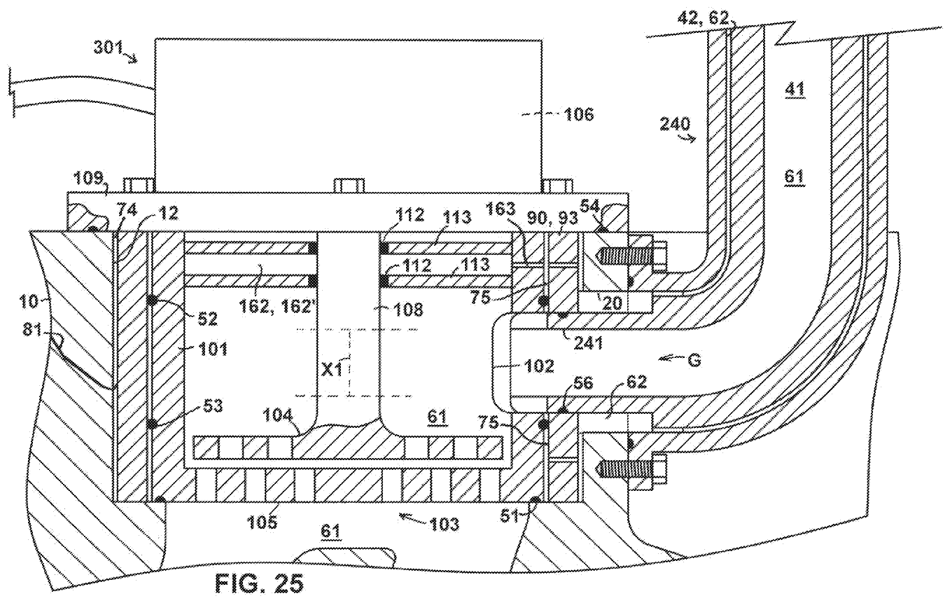

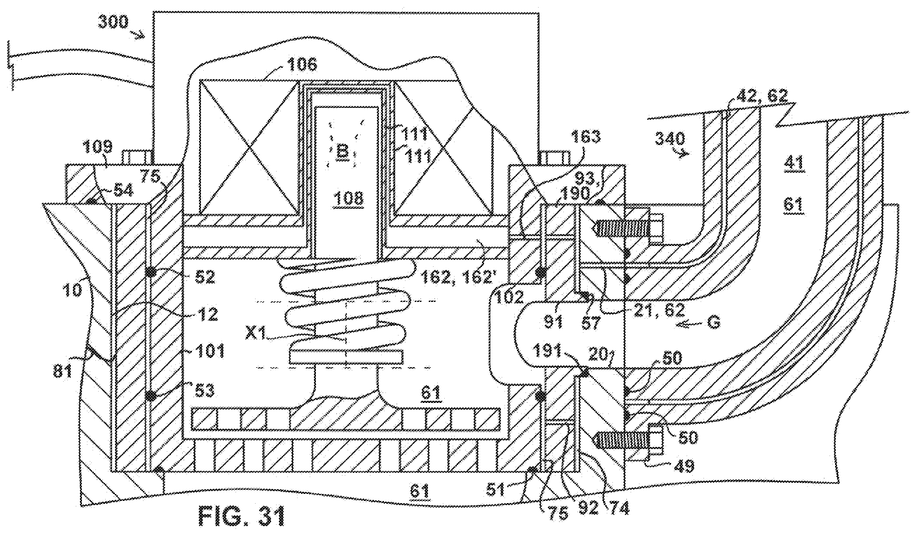

Each of the third and fourth assemblies as shown respectively in FIGS. 25 and 31 includes an insert 90, 190 which is formed separately from the housing 10. The insert and the solenoid operated gas admission valve are configured for installation in the compartment by inserting them along the length axis X of the compartment 11 via its first, open end 13.

As illustrated, each assembly may be configured so that the solenoid operated gas admission valve, or both the solenoid operated gas admission valve and the insert, may be removed and replaced in this way while the conduit assembly remains in its installed position.

In its installed, use position as shown in FIG. 25 and FIG. 31 respectively, the insert 90, 190 forms a barrier 93 which extends along the length axis X of the compartment 11 between the body 101 of the solenoid operated gas admission valve and the wall 12 of the housing 10 to surround the solenoid operated gas admission valve within the compartment 11.

The barrier 93 includes a fuel gas admission aperture 91 through which the fuel gas flowpath 61 passes, and an outer leakage containment space 74 is arranged between the barrier 93 and the wall 12 of the compartment 11.

Optionally, as shown in each of the third and fourth assemblies, one or more inner leakage containment spaces 75 may be defined between the barrier 93 and the body 101 of the solenoid operated gas admission valve. Each leakage containment space is sealingly connected in fluid communication with the leakage containment flowpath 62 of the conduit assembly which thus forms a fluidly continuous leakage containment flowpath 62 including the or each leakage containment space within the housing 11.

Optionally, one or more additional barriers may be provided between the body 101 of the solenoid operated gas admission valve and the wall 12 of the compartment 11, with the leakage containment space being formed between the body 101 and the wall 12 on either or both sides of the additional barrier or barriers.

Third assembly Referring to FIGS. 17-25, the third assembly includes a first insert 90 and a third conduit assembly 240.

The first insert 90 is formed as a cylindrical barrier 93 open at each end and having a fuel gas admission aperture 91 and two leakage containment apertures 92 formed approximately mid-way between its two ends,

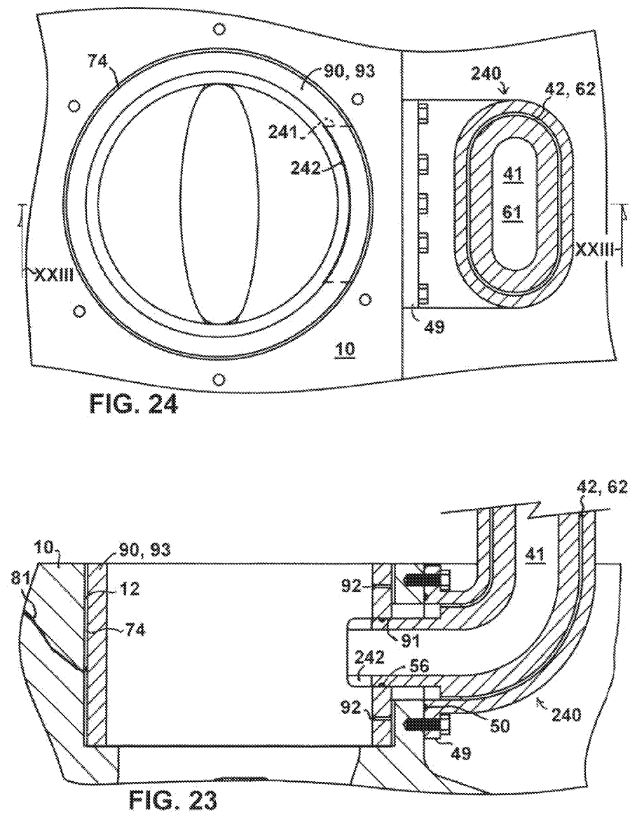

The third conduit assembly 240 comprises generally similar features to the first conduit assembly 40, and like the second conduit assembly has an extension 241 of the fuel gas conduit 41 beyond its connection flange 49. The extension terminates at a curved end surface 242 with a seal 56 which sealingly engages the fuel gas admission aperture 91 of the first insert 90 when both components are installed in their respective use positions as shown in FIG. 23.

In this position, the first insert 90 is fixed in the housing 11 by the extension 241 of the third conduit assembly, but the gas admission valve can be inserted into and removed from the space inside the first insert 90 via the open, upper end of the first insert 90 and compartment 11 without removing either the first insert or the third conduit assembly.

In the installed position of the solenoid operated gas admission valve 301 as shown in FIG. 25, the extension 241 of the fuel gas conduit 41 extends through the housing 10 via the first aperture 20 and into the compartment 11, and is sealingly connected directly to the barrier 93 in fluid communication with the fuel gas admission aperture 91 of the barrier.

An outer leakage containment space 74 is defined between the barrier and the wall 12 of the compartment 11, and extends as shown entirely around the gas admission valve and fluidly continuously over the entire axial length of the compartment 11 between seals 51 and 54 to surround the extension 241 of the fuel gas conduit 41 where it crosses the leakage containment space 74. The leakage containment conduit 42 fluidly communicates with the outer leakage containment space 74 via the first aperture 20 outside the extension 241, so that no fluid containment apertures 21 are required in the housing 10.

The leakage containment apertures 92 of the barrier 93 fluidly communicate with two inner, annular leakage containment spaces 75 formed between the barrier 93 and the body 101 of the gas admission valve, respectively between seals 51 and 53 and between seals 54 and 52. The annular space between the barrier 93 and the body 101 of the gas admission valve between seals 52 and 53 is filled with fuel gas. The upper one of the two inner leakage containment spaces 75 fluidly communicates with the leakage containment port 163 of the solenoid operated gas admission valve 301.

Optionally, the barrier 93 may include additional seals whereby it is sealed at its upper end to the mounting flange 109 of the valve body and at its lower end to the annular surface 15 of the housing.

It can be seen that a crack 81 forming in the wall 12 of the compartment 11 opens into the outer leakage containment space 74 and thus does not provide a Towpath through which fuel gas can escape to atmosphere.

### Fourth Assembly

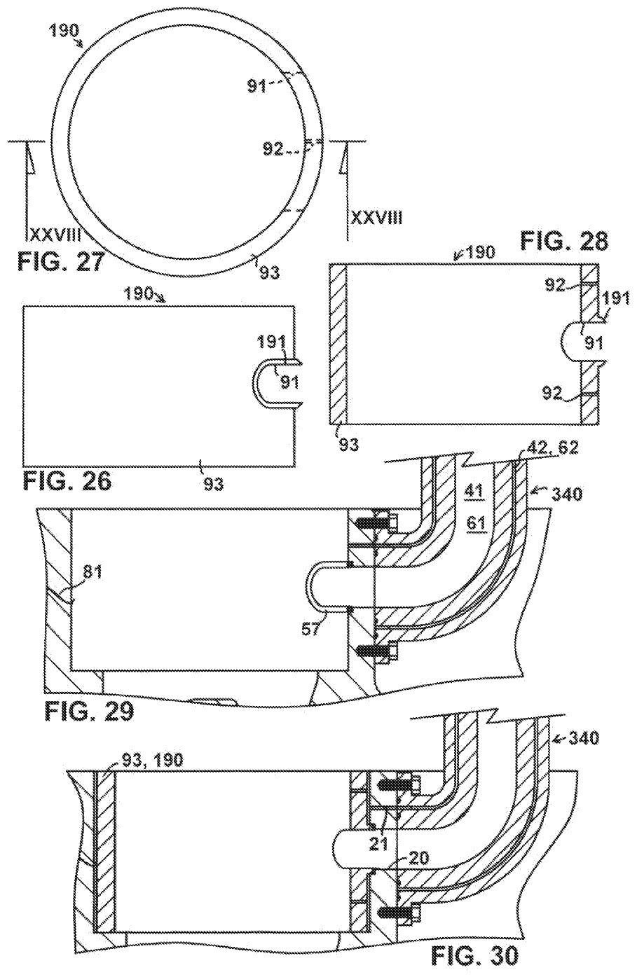

Referring to FIGS. 26-31, the fourth assembly includes a second insert 190 and a fourth conduit assembly 340.

Like the first insert, the second insert 190 is formed as a cylindrical barrier 93 open at each end and having a fuel gas admission aperture 91 and two leakage containment apertures 92 formed approximately mid-way between its two ends. Unlike the first insert, the second insert 190 has a sealing profile 191 surrounding the fuel gas admission aperture 91, and a seal 57 is arranged between the sealing profile 191 and the wall 12 of the compartment 11 surrounding the first aperture 20.

The fourth conduit assembly 340 comprises generally similar features to the first conduit assembly 40, which will not be described again.

As seen in FIG. 30, the barrier 93 is sealingly connected directly to the wall 12 of the compartment 11 with the fuel gas admission aperture 91 of the barrier in fluid communication with the first aperture 20 of the compartment 11. In the illustrated example, the sealed connection is provided by the seal 57 and complementary profile 191, although other possible arrangements will be evident to those skilled in the art.

The fuel gas conduit 41 and the leakage containment conduit 42 are sealingly connected to the housing 10 via the connection flange 49 of the fourth conduit assembly 340 in fluid communication respectively with the first aperture 20 and a small leakage containment aperture 21 which is formed in the housing 10 and opens through the wall 12 of the compartment 11 in a similar way to the leakage containment apertures 21 shown in FIG. 2, thus forming a fluidly continuous leakage containment flowpath 62.

The fourth conduit assembly 340 does not extend into the compartment 11, and so both the gas admission valve 300 and the insert 190 may be inserted and removed from the compartment 11 without removing the conduit assembly,

In the installed position of the gas admission valve 300 as shown in FIG. 31, the outer leakage containment space 74 and inner leakage containment spaces 75 are arranged generally as described above with reference to the third embodiment and so will not be described again, the respective parts and seals functioning in like manner. When fixed in position via machine screws or the like at its mounting flange 109 as shown, the gas admission valve may serve to centre the second insert 190 in the compartment 11. As in the third assembly, the upper one of the two inner leakage containment spaces 75 fluidly communicates with the leakage containment port 163 of the gas admission valve 300 which thus forms part of the fluidly continuous leakage containment flowpath 62.

### Fifth and Sixth Assemblies

In order to sealingly connect the fuel gas conduit in fluid communication with the inlet 102 of the valve body 101 within the compartment 11, the gas admission valve, or alternatively an insert for receiving the gas admission valve, may be introduced axially into the compartment 11 in a first movement, and then moved in a second movement in a different direction to the first movement to accomplish the seal.

The second movement may be a sideways translation of the valve body relative to the length axis of the compartment, as illustrated in the fifth and sixth assemblies. Alternatively for example the second movement could be a rotational movement of the valve body or the insert (not shown), with the sealing action being accomplished by suitably curved or inclined surfaces on the insert or the valve body and/or the inner wall 12 of the compartment 11.

In each case the compartment 11 is configured to accommodate the second movement of the valve or insert between the sealed and unsealed positions; where the valve body or insert is generally cylindrical and the second movement is in translation, this can be accomplished for example by enlarging the compartment slightly along the axis of movement, or simply by increasing its width or diameter.

A displacement means may be provided for exerting a displacement force against the valve body or insert so as to accomplish the movement from the unsealed position to the sealed position, and/or to maintain the valve or insert in the sealed position with the seal in its energised condition.

As illustrated by the fifth and sixth assemblies, the seal may be accomplished between an extension 441 of the fuel gas conduit and the outer surface of the gas admission valve or of the insert.

However, it will be appreciated that in alternative arrangements, as illustrated for example by the fourth assembly of FIG. 31, the fuel gas conduit may be sealingly connected to the housing 10 which is configured to define separate fuel gas and leakage containment flowpaths. The inner wall 12 of the compartment 11 may then be configured to define a suitable sealing surface surrounding the fuel gas flowpath, which engages a complementary surface on the valve body or insert, with the displacement means being used to move the respective component to the sealing position and/or to retain it in that position, as illustrated for example in FIG. 31.

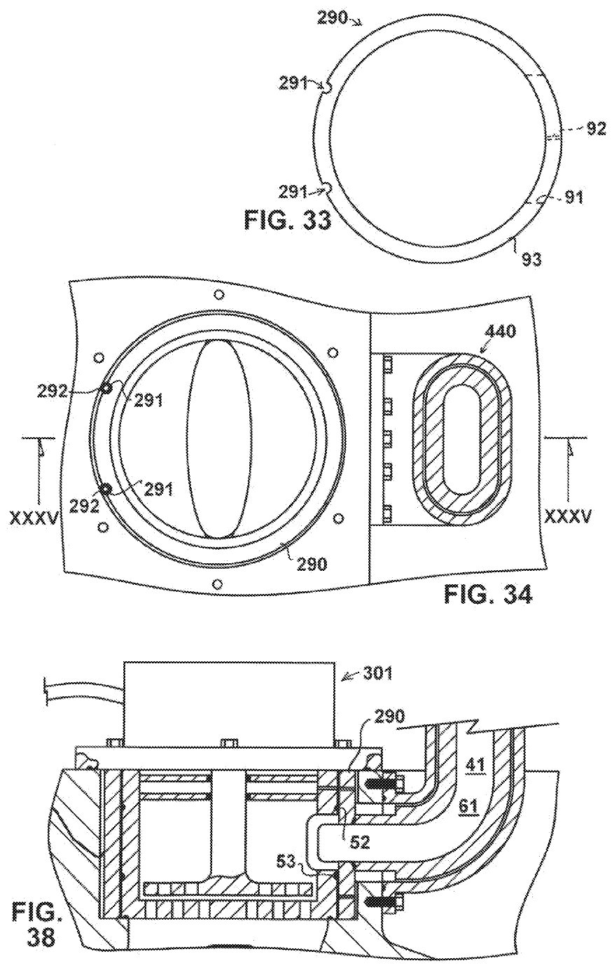

Referring to FIGS. 33-38 depicting the fifth assembly, the third insert 290 is generally similar to the first insert 90, having an inwardly chamfered fuel gas admission aperture 91 and two threaded channels 291 which extend axially along its outer surface on the opposite side of the insert from the fuel gas admission aperture 91. Conveniently, the channels may be formed by tapping two bores before machining away part of the outer surface of the generally cylindrical wall of the insert forming the barrier 93 to expose the threaded bores as channels in its outer surface.

The fifth conduit assembly 440 is generally similar to the third conduit assembly 240, except that the fuel gas conduit 41 terminates in a relatively shorter extension 441 which protrudes only a small distance into the gas admission valve compartment 11, with a ring seal 58 being arranged in a recess in its axial end face to surround the fuel gas flowpath 61 at the end of the fuel gas conduit.

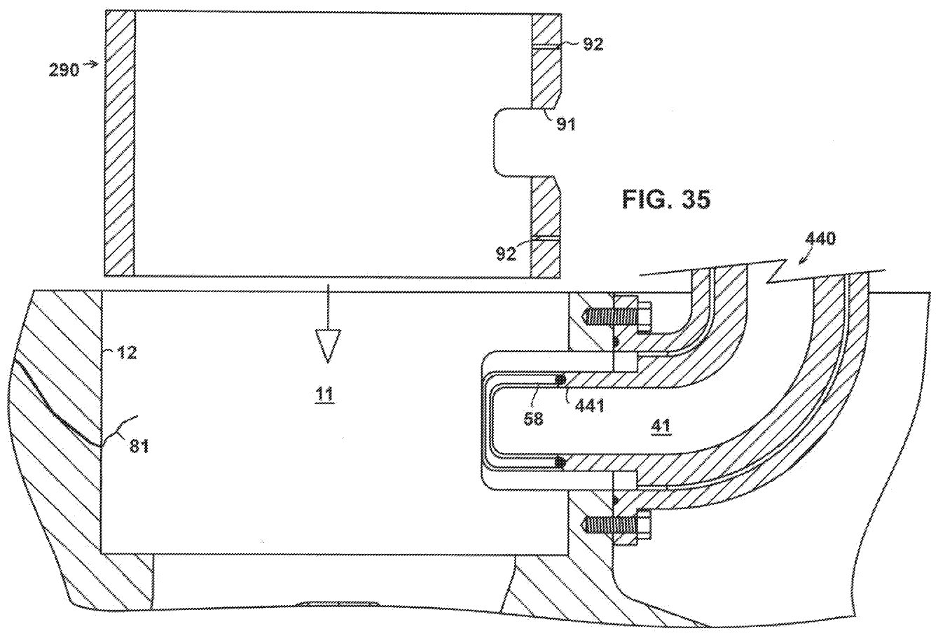

Since the extension 341 protrudes only a small distance into the compartment 11, the insert 290 can be inserted axially into the compartment (and removed the same way) with the conduit assembly in its installed position, as shown in FIG. 35.

In order to energise the seal 58 to seal the fuel gas conduit 41 in fluid communication with the fuel gas admission aperture 91 of the insert 290, two threaded screws 292 are installed in the threaded channels 291 and rotated to advance them into the channels.

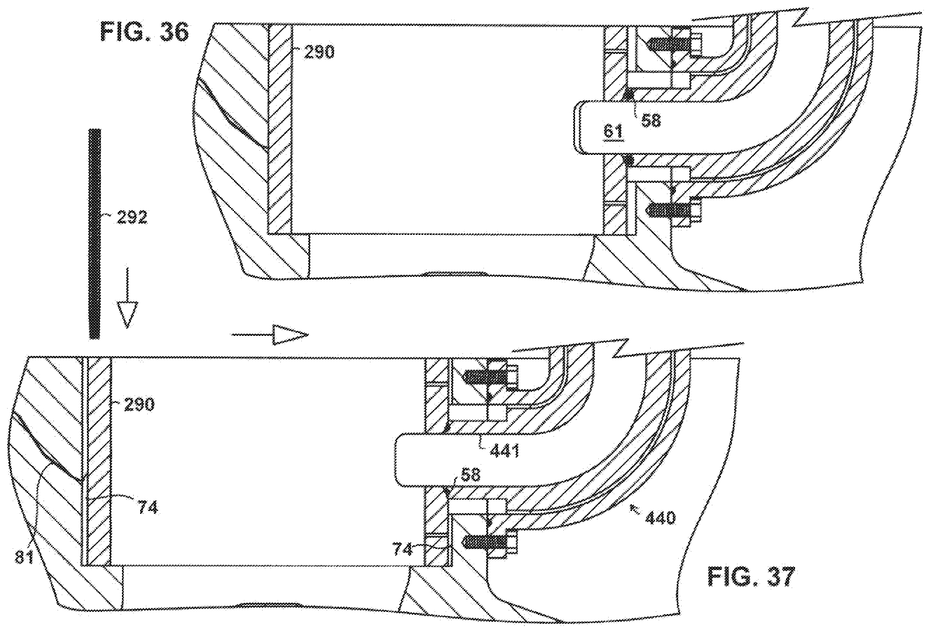

The screw threads protrude outwardly from the outer circumference of the insert 290 so that they bear against the inner wall 12 of the compartment 11, urging the insert 290 towards the extension 441 from the position of FIG. 36 so that the seal 58 is received in the chamfered fuel gas admission aperture 91 as shown in FIGS. 34 and 37. The screws 292 and channels 291 together form a displacement means which energises the seal 58 and maintains the insert 290 in the sealed position. The valve 301 can then be slidingly installed in the insert as shown in FIG. 38, wherein it can be seen that the fuel gas is contained in the inner annulus between the O-ring seals 52, 53 with the leakage containment space 74 arranged generally as described above with reference to FIGS. 25 and 31, with the screws 292 being retained in position beneath the mounting flange of the valve body. Since only the thread tips (which may be somewhat flattened) bear against the wall 12 of the compartment, any gas leaking into the leakage containment space 74 between the screws 292 may be evacuated to flow past the screws 292 between the wall 12 and the thread roots, or via recesses (not shown) machined into the channels 291 to provide a larger flowpath around each screw.

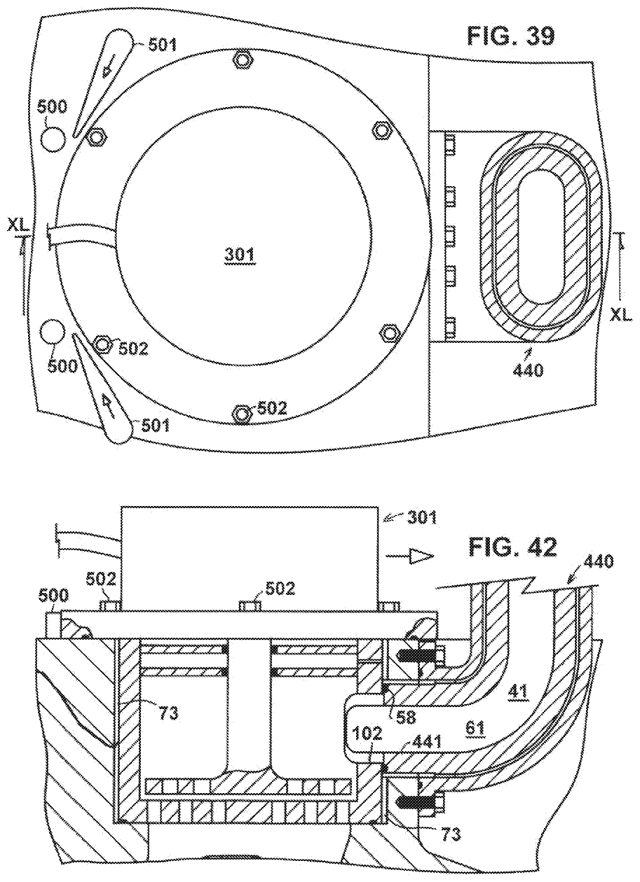

Referring now to FIGS. 39-42 depicting the sixth assembly, the fifth conduit assembly 440 is generally as previously described with reference to the fifth assembly, with the shape of the axial end face of the extension 441 being slightly modified. As in the fifth assembly, the extension 441 carrying the ring seal 58 protrudes a small distance into the gas admission valve compartment. The third solenoid operated gas admission valve is also as previously described and illustrated in FIG. 19, except for the O-ring seals 52 and 53 which are not required in this embodiment.

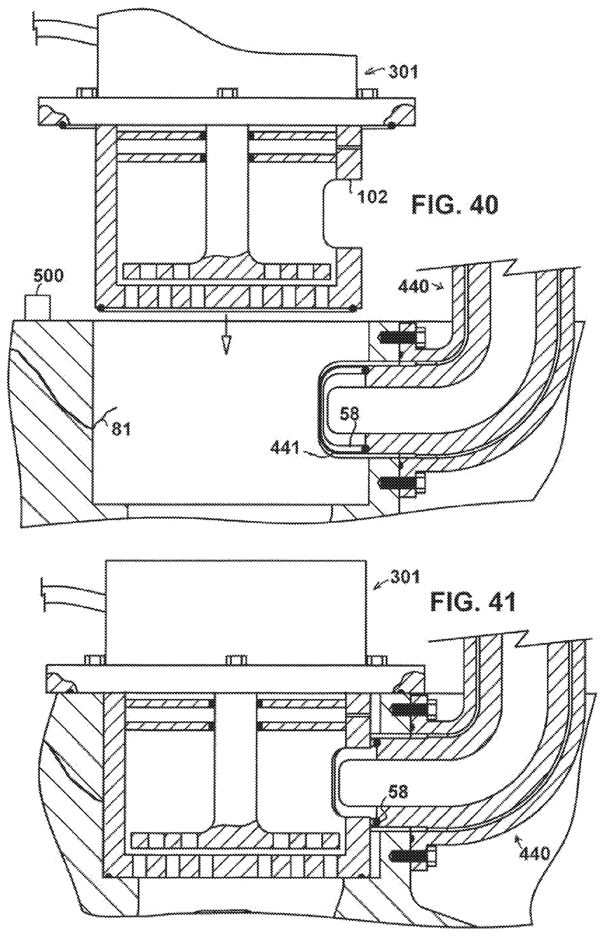

In the sixth assembly the displacement means comprises a pair of dowel pins 500 which extend axially from the upper face of the housing 10, and a pair of wedges 501. The valve 301 is introduced axially into the compartment 11 as shown in FIG. 40 before introducing the wedges between the dowel pins and the mounting flange of the valve 301. The wedges are tapped into the gap to urge the valve body from the position of FIG. 41 towards the extension 441, as shown by the arrow in FIG. 42. The sideways movement of the valve body energises the seal 58 which bears against the valve body to seal the fuel gas inlet 102 of the valve body in fluid communication with the extension 441 of the fuel gas conduit 41. In this position the screw holes in the mounting flange of the valve body align with the threaded screw holes in the housing 10, so that the valve body can be fixed in position by its mounting screws 502 as shown. The wedges are then removed leaving the body in the sealed position as shown in FIG. 42.

In both the fifth and the sixth assemblies, as in the previous embodiments, the fuel gas flowpath and the leakage containment space 73, 74 extend along and at least partially around a common portion of the length axis of the compartment 11. A crack 81 propagating through the wall 12 of the compartment 11 within the axial extent of the fuel gas flowpath thus communicates with the leakage containment space and not with the fuel gas flowpath.

The leakage containment space 73, 74 extends entirely around the length axis X of the compartment 11 both above and below (i.e. axially outward of) the fuel gas flowpath 61 where it crosses the leakage containment space 73, 74, so as to surround that portion of the fuel gas flowpath 61 which passes through the leakage containment space 73, 74. Further, as illustrated, the leakage containment space 73, 74 may extend fluidly continuously for the entire axial length of the compartment 11.

Of course, alternative displacement means can be used in place of the screws, channels, dowel pins and wedges illustrated. For example, the screws 292 may be received entirely within the wall of the insert and arranged to displace a ball which moves outwardly to engage the wall of the compartment 11. Many other possibilities will be evident to those skilled in the art.

### INDUSTRIAL APPLICABILITY

The novel gas admission valve and gas admission valve assembly may be used either separately or in combination to supply fuel gas to a gas or dual fuel internal combustion engine. The novel gas admission valve assembly provides a leakage containment space which can entirely surround the gas admission valve within the compartment of the housing, so that a crack penetrating the gas admission valve housing cannot form a leakage path to the external environment. The novel gas admission valve extends the leakage containment flowpath between the actuator (for example, the solenoid coil of a solenoid operated gas admission valve) and its internal fuel gas flowpath, so that any leakage of fuel gas within the gas admission valve is reliably excluded from its actuator, including its electrical power or sensing components if present. In combination, the novel gas admission valve and gas admission valve assembly provide a leakage containment flowpath which extends effectively continuously from the fuel gas supply conduit to the gas admission valve outlet.

Optionally, where the gas admission valve is a solenoid operated gas admission valve, actuation may be accomplished by the magnetic field of the solenoid which extends through the leakage containment flowpath within the valve, so that the leakage containment flowpath may be arranged without any moving parts and so that no moving parts of the valve pass through it, providing a particularly reliable assembly.

By arranging the gas admission valve in a housing forming a fixed or integral part of the cylinder head of the engine rather than on pipework external to the engine, a more compact assembly is obtained which also minimises any risk of leakage of the fuel/air mixture downstream of the gas admission valve. The resulting shorter flowpath and reduced volume downstream of the gas admission valve may also provide a more responsive fuel control system with reduced hysteresis.

By arranging the electrically powered solenoid coil or other actuator outside the fuel gas flowpath, the potential for ignition of leaking fuel gas by an electrical or mechanical fault is further reduced.

Where the novel assembly includes an insert surrounding the gas admission valve in the compartment 11, a crack developing in the cylinder head cannot propagate through the insert which thus provides yet further assurance of a gas tight assembly. The insert may be configured to provide a retrofit installation with little or no modification of the cylinder head, and is suitable for use in a compartment 11 of very simple shape, which provides easier manufacture and avoids complex shapes and thin sections which may potentially generate stress concentrations at which cracks may form.

By arranging the conduit assembly to terminate outside the compartment 11 (as in the example of FIG. 31) or at an insert (as in the example of FIG. 25) without extending into the space occupied by the gas admission valve, it is further possible to remove and replace the gas admission valve without disturbing the fuel gas supply conduit assembly, by extracting the gas admission valve axially from the compartment 11 or from the insert. This provides simpler maintenance of the gas admission valves, particularly on large engines where the fuel gas supply conduit assembly may be large and difficult to remove.

Optionally, as illustrated by the fifth and sixth embodiments, the fuel gas supply conduit may be sealingly connected in fluid communication with the gas admission valve, either directly or via an insert, so that the housing 10 does not form any part of the fuel gas flowpath 61, while still allowing the valve and insert (if any) to be removed and installed without disturbing the conduit assembly. Such arrangements ensure that the integrity of the fuel gas flowpath 61 upstream of the valve will be unaffected by any crack propagating through the housing 10.

In summary, a fuel gas supply assembly for an internal combustion engine 1 defines a leakage containment flowpath 62 which includes a leakage containment space 73, 74 formed between the body 101 of a gas admission valve 100, 200, 201, 300, 301 and the wall 12 defining the inner surface of a compartment 11 formed in the cylinder head 4 of the engine 1 in which the gas admission valve is mounted. The gas admission valve is sealingly connected in fluid communication with the fuel gas conduit 41 of a conduit assembly 140, 240, 340 via a first aperture 20 of the compartment 11 so that both the fuel gas flowpath 61 and the leakage containment space 73, 74 extend along and at least partially around a common portion X1 of the length axis X of the compartment 11. In another aspect, a gas admission valve includes an internal leakage containment flowpath 162 formed by a leakage containment compartment 162′ which is interposed between the actuator, e.g. a solenoid coil 106, and the fuel gas flowpath 61 within the gas admission valve and sealingly connected in use to the leakage containment flowpath 62.

Although the novel assembly has been illustrated using a solenoid operated gas admission valve, it will be understood that other types of gas admission valve may be employed, wherein the actuator may be for example a mechanical actuator, a pneumatic actuator, or a linear electric motor or other electrical actuator.

Many further possible adaptations within the scope of the claims will be evident to those skilled in the art.

In the claims, reference numerals and characters are provided in parentheses for ease of understanding and should not be construed as limiting features.

1. An assembly for supplying a fuel gas to a combustion chamber of an internal combustion engine, comprising:
a gas admission valve,
a housing, the housing forming apart of a cylinder head of the engine,
a conduit assembly,
a fuel gas flowpath, and
a leakage containment flowpath fluidly separated from the fuel gas flowpath;
the gas admission valve comprising:
a body, the body including an inlet and an outlet, the fuel gas flowpath extending within the body from the inlet to the outlet;
a valve element; and
an actuator operable to move the valve element to open and close the fuel gas flowpath to control a flow of fuel gas from, the inlet to the outlet;
the housing comprising:
a wall, the wall defining a compartment, the compartment having:
a first, open end;
a second end opposite the first end;
a length axis extending between the first and second ends;
a first aperture formed in the wall between the first and, second ends; and
a second aperture formed in the wall for fluidly connecting the compartment with the combustion chamber of the engine;
the conduit assembly comprising:
a fuel gas conduit, the fuel gas flowpath extending through the fuel gas conduit, and
a leakage containment conduit surrounding the fuel gas conduit, the leakage containment flowpath extending through the leakage containment conduit;
the gas admission valve being received in the compartment in a use position wherein:
the outlet of the gas admission valve is sealingly connected in fluid communication with the second aperture of the compartment, and
the leakage containment flowpath includes a leakage containment space arranged between the body of the gas admission valve and the wall of the compartment; and wherein
the inlet of the gas admission valve is sealingly connected in fluid communication with the fuel gas conduit via the first aperture of the compartment in an installed position of the conduit assembly, so that the fuel gas flowpath and the leakage containment space extend along and at least partially around a common portion of the length axis of the compartment.

2. An assembly according to claim 1, wherein the leakage containment space extends entirely around the length axis of the compartment to surround a portion of the fuel gas flowpath which passes through the leakage containment space.

3. An assembly according to claim 1, wherein the fuel gas conduit extends through the housing via the first aperture and into the compartment, and the leakage containment flowpath extends through the first aperture between the fuel gas conduit and the wall of the compartment.

4. An assembly according to claim 1, wherein the assembly includes an insert, the insert being formed separately from the housing, the insert and the gas admission valve being configured for installation in the compartment by insertion via the first, open end of the compartment;
the insert defining in an, installed, use position a barrier which extends along the length axis of the compartment between the body of the gas admission valve and the wall of the compartment to surround the gas admission valve within the compartment,
the barrier including a fuel gas admission aperture through which the fuel gas flowpath passes;
and the leakage containment space is arranged between the barrier and the wall of the compartment.

5. An assembly according to claim 1, wherein the assembly is configured to allow the gas admission valve to be removed from the compartment via the first, open end of the compartment in the installed position of the conduit assembly.

6. An assembly according to claim 1, wherein a leakage containment compartment is interposed between the actuator and the fuel gas flowpath within the gas admission valve, the leakage containment compartment forming part of the leakage containment flowpath.

7. An internal combustion engine comprising at least one combustion chamber and an assembly according to claim 1, wherein the compartment is fluidly connected with the combustion chamber via the second aperture of the compartment.

8. A gas admission valve for supplying a fuel gas to an internal combustion engine, the gas admission valve comprising:
a body, the body including an inlet and an outlet;
a fuel gas flowpath extending within the body from the inlet to the outlet;
a valve element; and
an actuator operable to move the valve element to open and close the fuel gas flowpath to control a flow of fuel gas from the inlet to the outlet;
wherein a leakage containment flowpath is interposed between the actuator and the fuel gas flowpath,
the leakage containment flowpath being fluidly separated from the fuel gas flowpath and sealingly connectable in an installed use position of the gas admission valve in fluid communication with an external leakage containment flowpath.

9. A gas admission valve according to claim 8, wherein the actuator is a solenoid, and no moving parts of the valve element extend through the leakage containment flowpath, and the valve element includes a magnet responsive element which is moveable by a magnetic field passing through the leakage containment flow/path.

10. A gas admission valve according to claim 8, wherein the valve element comprises a reciprocating stem which passes sealingly through the leakage containment flowpath .
